(19) United States
(12) Patent Application Publication
(10) Pub. No.: US 2014/0143261 A1
(43) Pub. Date: May 22, 2014

(54) AUTOMATED SEMANTIC ENRICHMENT OF DATA

(71) Applicant: INTERNATIONAL BUSINESS MACHINES CORPORATION, Armonk, NY (US)

(72) Inventor: Krishna R. Dhulipala, Tampa, FL (US)

(73) Assignee: International Business Machines Corporation, Armonk, NY (US)

(21) Appl. No.: 13/683,157

(22) Filed: Nov. 21, 2012

(51) Int. Cl. G06F 17/30

(52) U.S. Cl. CPC G06F 17/30286
USPC 707/752

(57) ABSTRACT

A computer receives real time equipment activity data, in an equipment interface protocol, from a manufacturing device. The computer reads commands from a computer file in a special purpose language and performs actions on the equipment activity data in accordance with the commands. Wherein the commands include one or more read commands for parsing the received equipment activity data in accordance with the equipment interface protocol. Wherein the commands include logic commands for conditionally performing a determination of output protocol, metadata to be added, additional data to be added, numerically and textually manipulations, identification, filtering, organizing, and buffering of data. Wherein the commands incorporate include commands for retrieving and adding data to the output data. Wherein the commands include one or more directives commands for inserting content containing executable commands or text. Wherein the commands incorporate build commands for creating the output data in accordance to the output protocol.

### FIELD OF INVENTION

The present invention relates generally to data processing, and more particularly to the semantic enrichment of equipment activity data transmitted by a manufacturing device.

### BACKGROUND OF INVENTION

Many devices utilized in manufacturing environments output data in various formats and protocols. These formats and protocols typically include only basic information such as the identity of the device and the associated sensor data. Due to the formatting structure of the device data, the data output by many devices can not be directly used by higher level systems, such as scheduling, analysis, and reporting systems. If the data from a device is desired for use by a higher level system, then enhancing the data, for example, by translation or the addition of another layer of data (metadata and/or additional data), can be required to provide the needed additional information, allowing the higher level systems and programs to properly read and use the device data.

The process of enhancing or adding higher level data to a data stream is typically referred to as semantic enrichment. Currently known semantic enrichment approaches typically utilize a dictionary, a template, and stored or real-time data. The dictionary is used to identify specific pieces of data in the input data, while the template provides the record layout of the output data and can also further identify specific pieces of data in the input data. The input data is searched to identify and capture pieces of data that are entered into the appropriate fields of the template, and an output record is written. Meaningful tags can be added to the output data where applicable. To identify and capture a subset of input data based on certain input record field values, the data can be processed by one or more field-level filters.

Each semantic enrichment program is typically developed and written to handle a specific protocol of a manufacturing machine found in a manufacturing environment. Known semantic enrichment approaches often requires the use of multiple enrichment programs, or variations of the same program, to handle a variety of input protocols. If minor changes occur to the input data protocol, such as changes in value ranges or certain changes to input record layouts, then the associated semantic enrichment program may not require modifications. However, when more than minor changes are required in how the input data is processed, or additional manufacturing equipment comes online with new protocols, then significant changes to the semantic enrichment program will usually be required. In what is often a time consuming and costly process, the semantic enrichment program is updated, re-compiled and re-deployed, resulting in a series of programs that are required to handle different output requirements for a given manufacturing device protocol, and to handle the multiple device protocols that may be found in a manufacturing environment.

In general, known semantic enrichment approaches are limited in how a user can express the desired enrichment of data using the templates and dictionaries mentioned above. In these approaches, the user defines the desired format of the output data and the enriching information, in typically an online system field by field, which is then held in databases or files. A program written in a traditional programming language then uses the stored information in databases or files to process machine data and produce the desired output. Such solutions typically lack the flexibility and expressiveness required to specify the desired enrichment of the output data in complex situations such as when input data must be skipped (depending on some conditions that occur in the input data), and when complex numeric and textual manipulations are needed to produce the desired output data. Known semantic enrichment approaches generally require multiple programs to handle all the above situations are often very large and yet can still lack needed functionality and flexibility.

### SUMMARY

Embodiments of the present invention provide a system, method, and program product for providing semantic enrichment of data. A computer receives real time equipment activity data from a manufacturing device, wherein the equipment activity data is in an equipment interface protocol. The computer reads commands from a computer file in a special purpose language and performs actions on the equipment activity data in accordance with the commands.

The commands include one or more read commands, executed by a read program module associated with the equipment interface protocol and located on the computer, for parsing the equipment activity data into data records including data fields in accordance with the equipment interface protocol.

The commands include one or more logic commands, executed by a logic program module located on the computer, for conditionally performing one or more of navigating through the equipment activity data by invoking read commands, determining metadata to be added to the output data, determining additional data to be added to the output data, numerically and textually manipulating the equipment activity data, and identifying, filtering, organizing, and buffering the input equipment activity data.

The commands include one or more include commands, executed by an include program module located on the computer, for retrieving and adding one or both of the determined metadata, and the determined additional data to the output data.

The commands include one or more directives commands, executed by a directives program module located on the computer, for inserting content containing executable commands or text, wherein the inserted content specifies one or more of an input protocol, an out protocols, a source of input data, and a destination of the output data.

The commands include one or more build commands, executed by a build program module located on the computer, for creating the output data in accordance to the output protocol, the output data including one or more of the data records, the data fields, the metadata, and the additional data.

### BRIEF DESCRIPTION OF THE FIGURES

FIG. 1 is a block diagram of data enrichment system, in accordance with an embodiment of the present invention.

FIG. 2 is a flowchart illustrating the steps of a semantic enrichment program of FIG. 1, in accordance with an embodiment of the present invention.

FIG. 3 is a flowchart illustrating the steps of a semantic enrichment program of FIG. 1, in accordance with an embodiment of the present invention.

FIG. 3 is a block diagram of internal and external components within the computing devices of FIG. 1, in accordance with an embodiment of the present invention.

### DETAILED DESCRIPTION

In order for equipment activity data from manufacturing devices and processes to be utilized by higher level programs such as process control programs and scheduling programs, the equipment activity data typically must be enriched and/or reformatted. The record layouts as defined by a protocol allows for the extraction of bit sequences of correct lengths for the interpretation of equipment activity data of several types. However, standards such as the SECS-II standard do not require inserting higher level metadata into the records, which can assist in interpreting the manufacturing device's raw equipment activity data.

A typical shop may have equipment from a variety of vendors, each with their own naming conventions. Therefore, even if a manufacturing device(s) does insert higher level metadata into the raw equipment activity data, then there is generally a need to enrich the raw equipment activity data using a common set of vocabulary. Thus, the raw equipment activity data has to be translated and/or enriched into names, structures and formats which can be understood by users as well as the information technology systems performing manufacturing execution, process control, and data analysis. For example, the SECS-II standard data stream output of several manufacturing devices includes informational data such as the type, length and occurrences of binary data that follows the raw equipment activity data. However, some manufacturing devices include additional text fields showing the meaning of the binary data, some manufacturing devices do not, and some of the manufacturing devices have different names for the same data. So, before the equipment activity data can be utilized by higher level program (e.g., a process control program) basic metadata (data about data) should be added to the output data.

Embodiments of the present invention will now be described in detail with reference to the accompanying drawings.

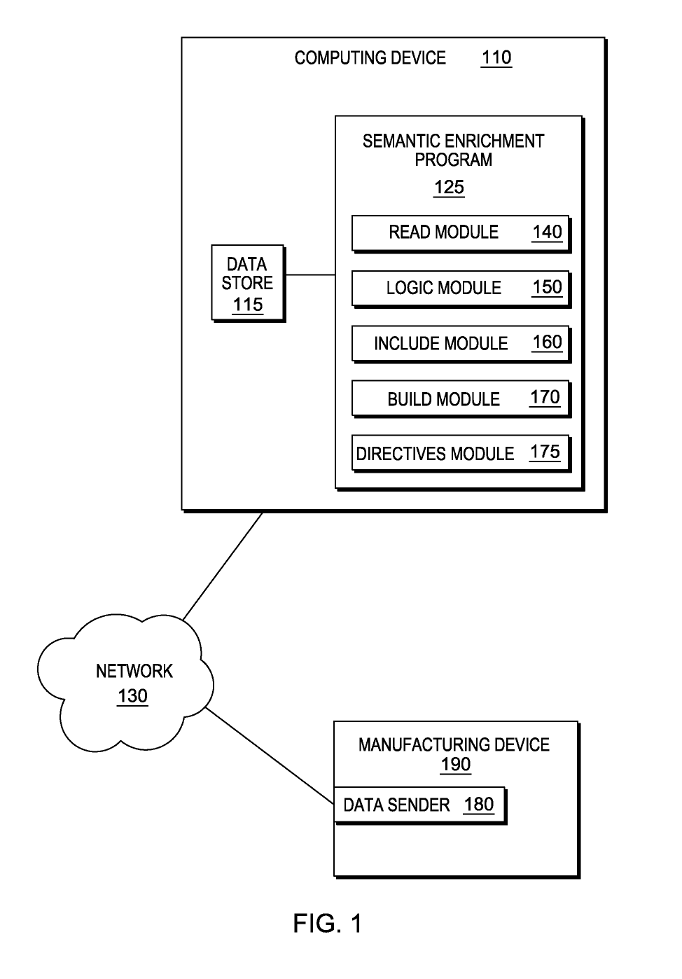

FIG. 1 is a block diagram illustrating equipment activity data system 100, which includes computing device 110 and manufacturing device 190, interconnected over network 130, in accordance with an exemplary embodiment of the invention.

Network 130 may be, for example, a local area network (LAN), a wide area network (WAN) such as the Internet, or a combination of the two, and may include wired, wireless, fiber optic or any other connection known in the art. In general, network 130 may be any combination of connections and protocols that will support communications between computing device 110 and manufacturing device 190 in accordance with one or more embodiments of the invention.

In embodiments of the invention, manufacturing device 190 represents one or more manufacturing devices on, for example, a shop floor that has the capability to communicate manufacturing information to a host computer, such as computing device 110. For example, manufacturing device 190 can represent a semi-conductor photolithography machine, a chemical vapor deposition machine, and a semiconductor die cutting machine, all located within a chip fabrication facility, each transmitting equipment activity data over network 130 to computing device 110. Each manufacturing device 190 includes a data sender 180, which represents a network interface capable of transmitting the equipment activity data in a respective equipment interface protocol generated by manufacturing device 190 over network 130. In an exemplary embodiment, data sender 180 uses a TCP/IP based network communication protocol to pass equipment activity data to computing device 110 via network 130.

In an exemplary embodiment of the invention, a manufacturing device 190 generates equipment activity data in accordance with the Semiconductor Equipment and Materials International Equipment Communications Standard, Part-2 (SECS-II) protocol, an equipment interface protocol which was developed and is distributed by Semiconductor Equipment and Materials International (SEMI). The SECS-II data is transmitted over network 130 to computing device 110 in accordance with the High-Speed SECS Message Services (HSMS) transport protocol, which is a TCP/IP based transport protocol designed for efficient communication of SECS-II data between SECS-II enabled devices.

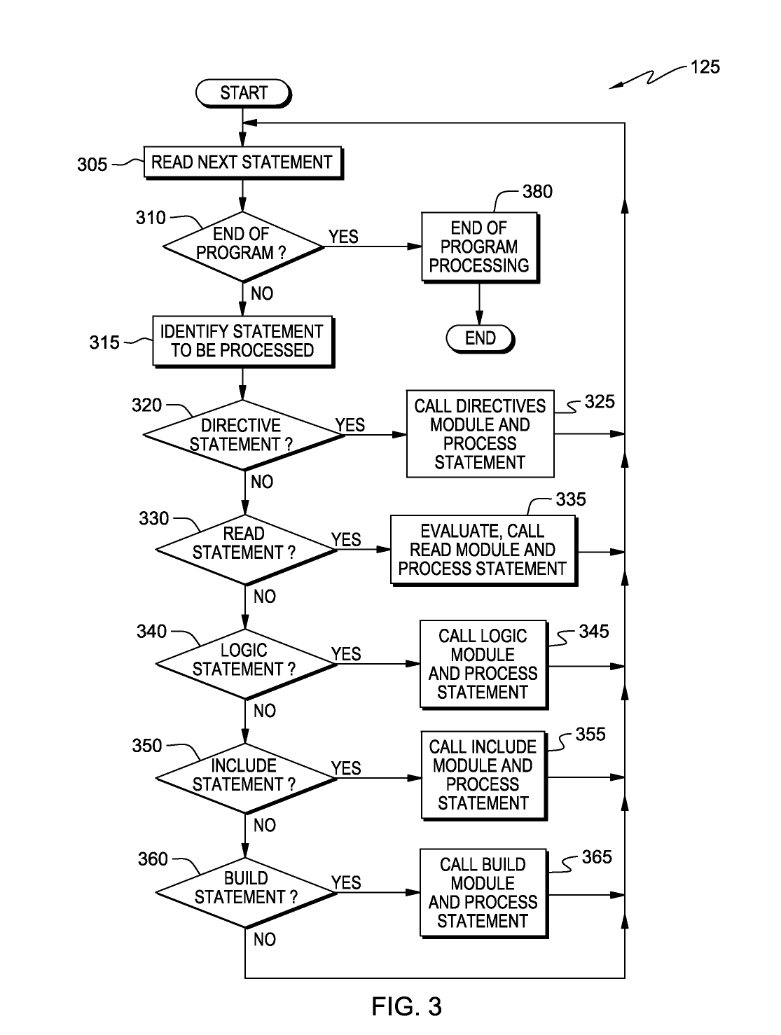

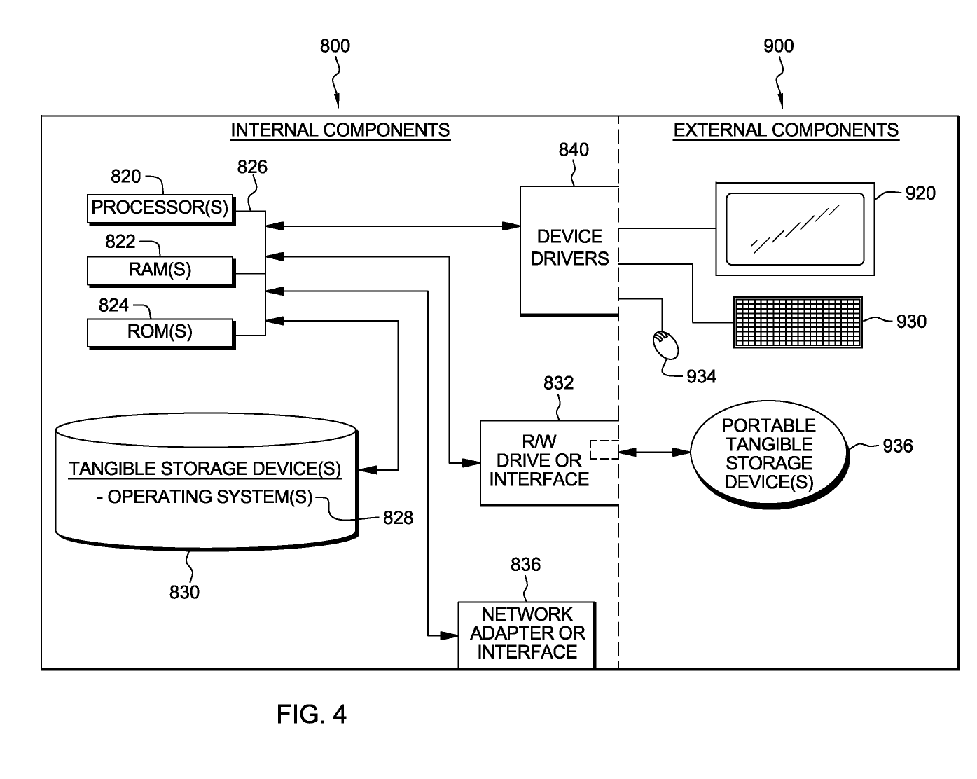

In various embodiments of the present invention, computing device 110 may be a server, a laptop computer, a tablet computer, a netbook computer, a personal computer (PC), or a desktop computer. In certain embodiments, computing device 110 represents computing systems utilizing clustered computers and components to act as a single pool of seamless resources. In general, computing device 110 can be any computing device or a combination of devices that has access to data store 115 and is capable of executing semantic enrichment program 125, which further includes one or more read module 140, logic module 150, include module 160, build module 170, and directives module 175 in accordance with embodiments of the invention. Computing device 110 is depicted and described in further detail with respect to FIG. 3.

In an exemplary embodiment of the invention, data store 115 includes commands that control the operation of semantic enrichment program 125, meta data, and additional data that may be included in the output data, and the output data, which is the enhanced, enriched, and reformatted equipment activity data produced by semantic enrichment program 125, all of which are explained in more detail below. After the output data has been stored on data store 115, the output data is available for further processing, such as by analysis and reporting programs. In certain other embodiments, the output data can also be transmitted, for example, as a message over a Message Queue, transmitted as a file, transmitted as a data stream over a TCP connection, to be further processed by other programs such as analysis and reporting programs.

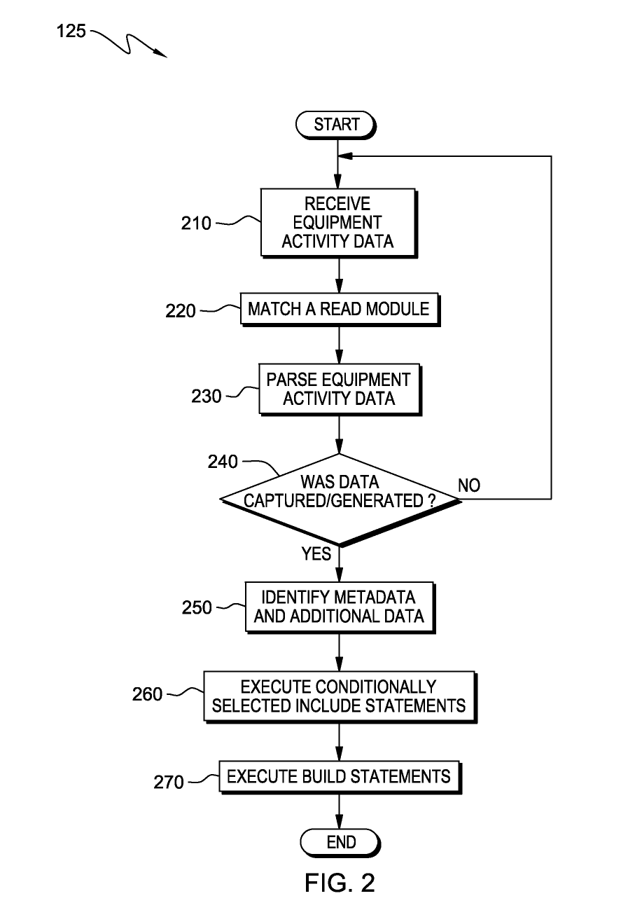

In an exemplary embodiment of the invention, semantic enrichment program 125 operates on equipment activity data received from manufacturing device 190 to enrich and reformat the received equipment activity data, and produce output data, the operation of which will be described in more detail below with respect to FIG. 2. Semantic enrichment program 125 is, in general, a modular program, which interprets commands in a special language. The modules include a swappable reader front end and pluggable writer back ends, for reading, manipulating, semantically enhancing, standardizing the record fields of real-time equipment activity data records received in different equipment interface protocols, and outputting the information in regular data structures, such as single, multiple, or tree type records.

Semantic enrichment program 125 operates generally by reading commands in a special purpose interpreted language from an input file, for example, on data store 115, and performing actions via its program modules (e.g., read module 140, logic module 150, include module 160, build module 170, and directives module 175) on received equipment activity data to produce output data. Generally, each special purpose interpreter language command statement causes semantic enrichment program 125 to call one of its modules and perform the action or actions indicated in the command statement. The selection of and execution of a given module is based on the type of command statement being interpreted.

In an exemplary embodiment, semantic enrichment program 125 includes one or more read module 140, logic module 150, include module 160, build module 170, and directives module 175. Read module 140 operates, in general, as a front end reader to read real-time equipment activity data received from a manufacturing device 190, and parse the data into defined fields. The parsed data may be stored in an intermediate buffer, for example a portion of RAM(S) 822 (see FIG. 3), to facilitate further enhancement. The parsed data can be reformatted into more convenient or usable formats. In preferred embodiments, a given read module 140 is associated with a specific equipment interface protocol. The information captured by read statements can include indicators, values, fields, or labels. Read module 140 can allow for variations such as reading and parsing multiple records, reading records in a primary with multiple sub-record structure, or, in conjunction with logic module 150 described below, discarding records that do not meet certain criteria, such as a certain string or value in a record field.

In a preferred embodiment, logic module 150, include module 160, and build module 170 acts in concert to produce output data. However, in some embodiments the functions of a given module may be incorporated into that of a different module (see discussion of FIG. 2 below). In general, logic module 150 interprets logic statements that direct the execution of read statements, build statements, include statements, and directives statements according to received commands. The read statements, build statements, include statements and directive statements in turn direct the activity of read module 140, include module 160, build module 170, and directives module 175 respectively. The logic statements interpreted by logic module 150 can further specify variables and assignment of values and references to those variables. In general, logic statements include program instructions for conditionally determining additional data to be added to the output data, numerically and textually manipulating the equipment activity data, and identifying, and filtering the parsed equipment activity data. The conditional execution of the previously mentioned functions can be dependent on a variety of criteria being met, which satisfy a logic statement. For example, a logic command can include an “if/then” statement which checks for a the recipe name value in the input data as being of a certain type of recipe and then proceeds to expect and process a certain block of input that is only exists if the recipe belongs to that type.

In a preferred embodiment, logic module 150 supports constructs such as “Loop”, “If”, “Then”, “Else”, and “While” statements in the logic statements. Logic module 150 can also support string, numeric or Boolean expressions in the constructs wherever these values are appropriate. In a preferred embodiment, logic module 150 supports string operators like the concatenation operator and/or several string functions. Similarly several numerical operators such as +, −, /, * are supported for forming numerical expressions. Several equality and inequality (both string and number) operators are supported for forming Boolean expressions. A manufacturing device can have variations in its data output which are related to the device's current function or application. For example, a variation may be due to the “recipe” or other process specifics being run on the manufacturing device. In another example, certain sections of the manufacturing device's equipment activity data may be missing, repeated, or added depending on the recipe. Logic statements interpreted by the Logic module 150 can be written to recognize the context of a given equipment activity data and then execute conditional logic to handle the input data. Logic statements can also be written to buffer data values from the input into variables such that the translated and enriched output can be built as desired even though the equipment activity data is not received in that sequence.

In a preferred embodiment, logic statements, to be interpreted by the logic module 150, can be coded for the determination of or identification of metadata and/or additional data to be included in or used in the production of an output data. For example, the receipt of equipment activity data that originated from a silicon doping device results in the identification, by a logic command, of required recipe tolerances for the doped silicon being produced by way of a positive test on a conditional check. The positive test on the logic command invokes the necessary include statements to retrieve the additional data (i.e., the recipe tolerances) from an appropriate source and build statements to output the equipment data and the additional data in the desired format.

In the preferred embodiment, include module 160 interprets include commands to retrieve and include a variety of metadata and/or additional data, in the output data. For example, statements executed by include module 160 can result in the inclusion of data from external files and databases within the output data.

In an exemplary embodiment, metadata is descriptive data that includes information such as the descriptive label size and format of data embedded in an output data and further defines and/or associates context to the characteristics, traits and use of manufacturing devices, items, tools and processes i.e., data about manufactured items and or the equipment/processes that created them. Additional data includes indicators, values, fields, data from files, and labels that are retrieved by and/or generated by one or more modules of semantic enrichment program 125. Additional data can include information such as the operating history for a given manufacturing device, a range for a rate of production, a number of objects produced by the manufacturing device, a number of produced objects that pass quality control inspection, a list of manufacturing devices involved in the production of an end product, a rate of production of the end product, and a limiting factor in the rate of production of the end product. For example, read and logic program statements interpreted by the semantic enrichment program 125 can receive equipment activity data from a wafer manufacturing device which indicates that the wafer manufacturing device has processed 43 microchips in the last hour. Include statements then retrieve the acceptable production range for the wafer manufacturing device, e.g. 40-45 chips an hour, from an external file and enter that information into specific variables. Build statements then use those variables to add the identified range to the output data.

In a preferred embodiment, build module 170 interprets build commands which use parsed equipment activity data (e.g., parsed Interface A data or SECS II data), calculated or otherwise manipulated data, additional data, and metadata to produce structured output that can, for example, be hierarchical, e.g., XML, JavaScript® Object Notation (JSON) or Hyper-Text Markup Language (HTML) output. In general, build commands create the output data in accordance to the output protocol, the output data including one or more of the data records, the data fields, the metadata, and the additional data. In an exemplary embodiment, build module 170 can produce two types of output data. The first type is a non-leaf node in an XML/HTML/JSON output along with its attribute name/value pairs. The second type is arbitrary text like the node values for leaf-nodes in an XML/HTML/JSON output. Build statements can also work in concert with logic statements to guide the build. For example, a build can include logic statements to capture a specific data in a record and then move on to the next record if the specific data was not found. In some embodiments, it is possible to enhance the build statement syntax to include other types of output.

In an exemplary embodiment, a typical output data includes data records, reports, values, indicators, fields, files and labels which are built using parsed equipment activity data, and metadata/additional data which is identified and added by logic commands and include commands respectively.

In a preferred embodiment, directives module 175 interprets directive commands to insert other semantic enrichment language program files or plain text files at the point of insertion, assign input and output channels to user-specified end-points such as files, standard input channel, and a standard output channel. Directive commands can also specify the input protocol of the data and specify the output protocol of the build module.

In an exemplary embodiment, a semantic enrichment program file has directive statements to file-include other semantic enrichment program files which in turn can file-include yet other semantic enrichment program files. The first phase of the semantic enrichment processor program 125 resolves the file-include commands and inserts the contents of the included files at the point of the file-include statement and effectively create a continuous program which is then processed by the second phase of the language processor program.

In certain embodiments, a number of variations of equipment activity data system 100 may be implemented. For example, semantic enrichment program 125 can execute a variety of statements to generate additional data to build the output data, such as averages or cumulative values, which are then combined with the captured information. In another example, there can be several additional outputs besides the main output of transformed enriched equipment activity data, i.e., secondary outputs such as summaries, lists, outlines etc. In yet another example, additional outputs can be activated, suppressed and/or redirected using one of the directive statements. The output data may also be filtered and distributed to several consumers. Further processing, such as filtering and distribution, is typically handled outside of the equipment activity data system 100. However, it can also be handled using semantic enrichment program 125 by extending the set of directive statements to direct the filtering and distribution of the output equipment activity data.

In a further example, to add the capability to buffer input equipment activity data and variables, semantic enrichment program 125 may be provided with additional directive/logic statements to scan the input for collecting variable values without producing any output. Buffering the input equipment activity data could be useful in scenarios where most or all of the input equipment activity data has to be scanned before producing any output, such as when there are multiple reads or a number of separate data items that are required to build a given output. Buffering of input equipment activity data may also be achieved through the use of multiple parsing passes of the input equipment activity data.

In a yet further example, the semantic enrichment program 125 may execute the input program directly (interpreted code) or can generate an in intermediate form of code, store it and use it at run time (compiled code).

In a last example, the components of semantic enrichment program 125 (e.g. read module 140) can be built to function as independent units. Such an application of semantic enrichment program 125 could be useful in, for example, generating test XML data to be used by a testing team for an application. It is to be appreciated that semantic enrichment program 125 can be applied to any number of scenarios where the input data has a structured format that can be described by a grammar syntax and there is labeling of data or another form of enrichment of data that needs to be applied to the input in order to generate a desired structured output.

FIG. 2 is a flowchart illustrating the function of semantic enrichment program 125 operating on computing device 110, for the generation of enriched equipment activity data in accordance to an exemplary embodiment. As described above, the operation of semantic enrichment program 125 is controlled by reading commands in a special purpose interpreter language from an input file on data store 115, and performing actions via its program modules. In this embodiment the various functions and properties of directives module 175 have been incorporated into logic module 150 include module 160 and build module 170, thereby eliminating the need for a separate directives module 175.

In a preferred embodiment, semantic enrichment program 125 receives equipment activity data from manufacturing device 190 (step 210). Semantic enrichment program 125 executes the commands stored in data store 115 and the equipment activity data is matched/passed to an appropriate read module that is included in read module 140 (step 220). Based on the protocol of the received equipment activity data, the appropriate read module 140 parses the equipment activity data and captures information such as values and data elements (step 230).

Logic module 150 determines if the information needed to build an output data has been captured and/or generated (decision 240). If the needed information has not been captured and/or generated (decision 240, “no” branch), then logic module 150 executes a return to and continuation of reading, parsing and capturing information from equipment activity data (steps 210, 220 and 230 respectively). If logic module 150 determines that the needed information to build an output data has been captured and/or generated (decision 240, “yes” branch), then logic module 150 identifies metadata and further additional data to be included in the output data (step 250).

After all the needed information to build an output data has been captured or generated (decision 240, “yes” branch), logic module 150 executes statements to identify metadata and additional data that is related the captured information (step 250). The identified metadata and additional data is then flagged for inclusion in the output data. Logic module 150 then conditionally selects include statements for execution by include module 160, which will include the flagged metadata and additional data in the output data. For example, the received equipment activity data includes the identification number for a manufacturing device. Logic module 150 searches a database for, and identifies/flags, records indicating the manufacturing process that is currently utilizing the manufacturing device. The flagged records are prepared to be included in the output data and the respective include statements of include module 160 executed.

Include module 160 executes the conditionally selected include statements to retrieve and add the flagged metadata and/or additional data to the captured information, according to the direction of logic module 150 (step 260). All captured information (which now includes additional data and metadata) is then passed to build module 170 for output to data store 115. For example, responsive to the identification of flagged metadata and additional data, include module 160 executes include statements according to the direction of logic module 150. The identified flagged information is retrieved and combined with the captured information to be used in the building of a data output by build module 170.

Build module 170 executes various build statements to combine and format the captured information to form an output data (step 270). The output of build module 170 is a semantically enriched data file, i.e., the completed output data structure(s) that form output records and/or output record segments (i.e., output data). The output data is passed to and saved in data store 115. Data store 115 can then pass the output data to a downstream process, such as a manufacturing scheduling program.

FIG. 3 is a flowchart illustrating the function of one embodiment of semantic enrichment program 125 operating on computing device 110, for the generation of enriched equipment activity data in accordance to an exemplary embodiment. As described above, the operation of semantic enrichment program 125 is controlled by reading commands in a special purpose interpreted language program, from an input file included in data store 115, and performing actions via its program modules. It should be noted that, in this exemplary embodiment, all special interpreted language programs will include one or more protocol and channel directives statements.

In a preferred embodiment, semantic enrichment program 125 reads the next statement (command) from the special interpreted language program which was loaded from data store 115 (step 305). If no further commands are identified, then semantic enrichment program 125 confirms whether or not the end of the program has been reached (decision step 310). If the end of the program has been reached (decision step 310, yes branch) then semantic enrichment program 125 proceeds with the end of program processing (step 380).

If the end of the program has not been reached (decision step 310, no branch) then semantic enrichment program 125 identifies the command (to be processed) that has been read from the program file and passes it to the appropriate module for processing depending on the statement type. If the command to be processed is an end of block statement, then semantic enrichment program 125 determines whether or not to exit the block context based on the type of block context that is currently active (not shown). Since an end of block statement can be encountered at multiple points and in multiple types of statements the programming to process an end of block statement is included in each respective module of semantic enrichment program 125 (i.e., the directive, read, logic, include, and build modules) and each module is able to execute an end block command.

Semantic enrichment program 125 first identifies if the statement to be processed is a directive statement (decision step 320). If the statement to be processed is a directive statement (decision step 320, yes branch), then semantic enrichment program 125 calls the directives module, determines the sub type of the statement and processes the directive statement according to the directive module programming (step 325). For example, if the statement is a protocol directive statement, then directives module 175 loads the appropriate read module 140 and one or more build modules 170 for executing the read and build statements to be utilized later by semantic enrichment program 125 to generate an output data. In another example, if the statement is a channel directive statement, then directives module 175 executes the directives statement to define the specified input or output channel names, open the specified sources and destinations in an appropriate manner and assign them to the channels, respectively.

In this exemplary embodiment, read and build statements written in the special interpreted language program can refer to channels instead of the actual sources and destinations of data. For example, if the statement is a file-include directive statement, then directives module 175 opens and reads the specified file and inserts the contents of the read file at the specified point in the special interpreted language program. If the statement to be processed is not a directive statement (decision step 320, no branch), then semantic enrichment program 125 determines if the statement is a read statement (step 230).

If the statement to be processed is a read statement (decision step 330, yes branch), then semantic enrichment program 125 first evaluates any expressions in the statement to a numerical, textual or Boolean value (semantic enrichment program 125 supports several numerical, textual and Boolean operators and expressions). semantic enrichment program 125 then calls an appropriate read module (of read modules 140), which is matched to the protocol of the received equipment activity data, to read and parse the next portion of received equipment activity data and capture information such as values and data elements which are returned as parsed values (step 335). The parsed values are available as variables to facilitate future processing of program statements by semantic enrichment program 125. If the statement to be processed is not a read statement (decision step 330, no branch), then semantic enrichment program 125 determines if the statement is a logic statement (decision step 340).

If the statement is a logic statement (decision step 340, yes branch), then semantic enrichment program 125 calls logic module 150 and processes the logic statement. (It should be noted that in some embodiments semantic enrichment program 125 itself can act as the logic module; hence there would be no need to load a separate logic module). In this embodiment, semantic enrichment program 125 first determines the sub type of the logic statement and then processes the statement accordingly (step 345). For example, if semantic enrichment program 125 determines the sub type to be an assign type statement, then semantic enrichment program 125 evaluates any expressions and stores the value of the right hand side of an assignment statement in the variable on the left hand side. In another example, if semantic enrichment program 125 determines the sub type to be a loop statement, then semantic enrichment program 125 evaluates any expressions in the statement. Semantic enrichment program 125 then creates a context for the loop-block to maintain parameters such as the scope of the block and number of times of looping. In yet another example, semantic enrichment program 125 determines if the information needed to build an output data has been captured and/or generated. If not the information needed to build an output data has been captured and/or generated, then semantic enrichment program 125 executes a return to and continuation of reading, parsing and capturing information from equipment activity data.

Loop statements in the special interpreted language program allow the user to loop through a set of statements in a loop-block. In this exemplary embodiment, the special purpose semantic enrichment language is a block structured language, meaning semantic enrichment program 125 can support the creation of blocks of program statements, including blocks that can be nested within other blocks. A loop-block is a special type of block which allows repeated execution of the block a specified number of times. In another example, if semantic enrichment program 125 determines the sub type to be an if-else statement, then semantic enrichment program 125 evaluates any expressions in the statement and calculates the truth value of the condition associated with the if-else statement. Semantic enrichment program 125 then creates a context for the if-else block to maintain parameters such as the scope of the block of statements to be executed depending on the truth value calculated.

If the statement to be processed is not a logic statement (decision step 330, no branch), then semantic enrichment program 125 determines if the statement is an include statement (decision step 350). If the statement is an include statement (decision step 350, yes branch), then semantic enrichment program 125 calls include module 160 and processes the include statement. To process an include statement, semantic enrichment program 125 first determines the sub type of the include statement and then processes the statement accordingly using include module 160.

For example, in case of a file-access statement, semantic enrichment program 125 evaluates any expressions first, then semantic enrichment program 125 calls the include module 160 to execute the statement to perform various operations such as opening the file, seeking and reading the data, parsing the data and closing the file. Any values read will be retained and made available for use as additional data. In another example, semantic enrichment program 125 determines the include statement to be a database-access statement. To process database-access statements semantic enrichment program 125 first evaluates any expressions first, then semantic enrichment program 125 calls include module 160 to execute the statement to perform various operations (such as getting a connection to the database, reading the data, parsing the data and closing the connection). The values read will be retained and be made available as additional data (step 355).

If the statement to be processed is not an include statement (decision step 350, no branch), then semantic enrichment program 125 determines if is a build statement (decision step 360). If the statement is a build statement (decision step 360, yes branch), then semantic enrichment program 125 determines the sub type of the build statement and processes the statement accordingly (step 365). If the build statement is a single statement for producing normal output including leaf nodes in a hierarchical output, then semantic enrichment program 125 evaluates any expressions in the input equipment activity data and then calls a build module to output a leaf node tailored to be included in a hierarchical output.

If the build statement is a block statement meant for producing a non-leaf node in a hierarchically structured output, then semantic enrichment program 125 evaluates any expressions in the input equipment activity data first. Then, semantic enrichment program 125 executes the build statement, which contains the necessary data, metadata and additional data, to call one or more build modules, pass on necessary data, metadata and additional data. The build module(s) then pass the output to the assigned output channel(s) according to the output protocol of the build module. For example, if the build statement is a block type build statement, after semantic enrichment program 125 evaluates any expressions in the input equipment activity data, then semantic enrichment program 125 executes the build statement. The build module(s) produce non-leaf output to the assigned output channel according to the output protocol of the build module. Semantic enrichment program 125 then creates a build-block context for maintaining the parent context in a hierarchical output (not seen in leaf node output). The output of non-leaf node type data can include sequence group nodes, choice group nodes and root nodes.

If semantic enrichment program 125 is unable to identify further statements to be interpreted and executed, then semantic enrichment program 125 will determine that the program has ended (decision 310, yes branch) and then perform end of program processing which may include items such as closing open files and open database connections (step 380). In certain embodiments, the end of program processing may include producing several additional outputs besides the main outputs of transformed enriched equipment activity data, for example, secondary outputs such as summaries, lists, outlines etc.

FIG. 4 is a block diagram of internal and external components within the computing device of FIG. 1, in accordance with an embodiment of the present invention. Computing device 110 internal components 800 and external components 900 are illustrated in FIG. 3. Internal components 800 include one or more processors 820, one or more computer-readable RAMs 822 and one or more computer-readable ROMs 824 on one or more buses 826, one or more operating systems 828 and one or more computer-readable tangible storage devices 830. The one or more operating systems 828 and programs semantic enrichment program 125, read module 140, logic module 150, include module 160, build module 170, and directives module 175 for computing device 110 are stored on one or more of the computer-readable tangible storage devices 830 for execution by one or more of the processors 820 via one or more of the RAMs 822 (which typically include cache memory). In the illustrated embodiment, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Internal components 800 also includes a R/W drive or interface 832 to read from and write to one or more portable computer-readable tangible storage devices 936 such as a CD-ROM, DVD, memory stick, magnetic tape, magnetic disk, optical disk or semiconductor storage device. The programs semantic enrichment program 125, read module 140, logic module 150, include module 160, build module 170, and directives module 175 for computing device 110 can be stored on one or more of the portable computer-readable tangible storage devices 936, read via the R/W drive or interface 832 and loaded into the hard drive or semiconductor storage device 830.

Internal components 800 also includes a network adapter or interface 836 such as a TCP/IP adapter card or wireless communication adapter (such as a 4G wireless communication adapter using OFDMA technology). The semantic enrichment program 125, read module 140, logic module 150, include module 160, build module 170, and directives module 175 for computing device 110 can be downloaded to the computing/processing devices from an external computer or external storage device via a network (for example, the Internet, a local area network or other, wide area network or wireless network) and network adapter or interface 836. From the network adapter or interface 836, the programs are loaded into the hard drive or semiconductor storage device 830. The network may comprise copper wires, optical fibers, wireless transmission, routers, firewalls, switches, gateway computers and/or edge servers.

External components 900 includes a display screen 920, a keyboard or keypad 930, and a computer mouse or touchpad 940. Internal components 800, also includes device drivers 840 to interface to display screen 920, keyboard or keypad 934 and computer mouse or touchpad 934. The device drivers 840, R/W drive or interface 832 and network adapter or interface 836 comprise hardware and software (stored in storage device 830 and/or ROM 824).

The programs can be written in various programming languages (such as Java, C++, Java Compiler Compiler™ (JavaCC™)) including low-level, high-level, object-oriented or non object-oriented languages. Alternatively, the functions of the programs can be implemented in whole or in part by computer circuits and other hardware (not shown).

Based on the foregoing, a computer system, method and program product have been disclosed for the semantic enrichment of data. However, numerous modifications and substitutions can be made without deviating from the scope of the present invention. Therefore, the present invention has been disclosed by way of example and not limitation.

What is claimed is:

1. A method for providing semantic enrichment of data, comprising the steps of:
a computer receiving real time equipment activity data from a manufacturing device, wherein the equipment activity data is in an equipment interface protocol; and
the computer reading commands from a computer file in a special purpose language and performing actions on the equipment activity data in accordance with the commands;
wherein the commands include:
one or more read commands, executed by a read program module associated with the equipment interface protocol and located on the computer, for parsing the equipment activity data into data records including data fields in accordance with the equipment interface protocol;
one or more logic commands, executed by a logic program module located on the computer, for conditionally performing one or more of determining an output protocol for an output data, determining metadata to be added to the output data, determining additional data to be added to the output data, numerically and textually manipulating the equipment activity data, and identifying, filtering, organizing, and buffering the input equipment activity data;
one or more include commands, executed by an include program module located on the computer, for retrieving and adding one or both of the determined metadata, and the determined additional data to the output data;
one or more directives commands, executed by a directives program module located on the computer, for inserting content containing executable commands or text, wherein the inserted content specifies one or more of an input protocol, an out protocols, a source of input data, and a destination of the output data; and
one or more build commands, executed by a build program module located on the computer, for creating the output data in accordance to the output protocol, the output data including one or more of the data records, the data fields, the metadata, and the additional data.

2. The method of claim 1, wherein the equipment activity data is received in a plurality of equipment interface protocols, and wherein each of the equipment interface protocols is associated with one of a plurality of read program modules, located on the computer, for executing the one or more read commands for parsing the equipment activity data into data records including data fields in accordance with the equipment interface protocol.

3. The method of claim 1, wherein the additional data is one or more of an indicator, a value, a field, a data from one or more files, a label, an operating history for a given manufacturing device, a range for a rate of production, a number of objects produced by the manufacturing device, a number of produced objects that pass quality control inspection, a list of manufacturing devices involved in the production of an end product, a rate of production of the end product, and a limiting factor in the rate of production of the end product.

4. The method of claim 1, wherein the step of one or more logic commands executed by a logic program module, located on the computer, the logic commands causing the computer to determine an output protocol for an output data, to determine metadata to be added to the output data, and to determine additional data to be added to the output data includes:
the computer identifying a relationship between the equipment activity data and one or both of the metadata or the additional data.

5. The method of claim 1, wherein the output data includes one or more of data records, reports, values, indicators, fields, files and labels.

6. The method of claim 1, wherein the metadata includes, for at least one of a manufacturing device, an item, a tool, or a process, one or more of a context for a characteristic, a use, a descriptive label for a data, a size of a data, and a format of a data embedded in an output data.

7. A computer system to provide semantic enrichment of data, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive real time equipment activity data from a manufacturing device, wherein the equipment activity data is in an equipment interface protocol; and
program instructions to read commands from a computer file in a special purpose language and perform actions on the equipment activity data in accordance with the commands;
wherein the commands include:
one or more read commands, executed by a read program module associated with the equipment interface protocol and located on the computer, for parsing the equipment activity data into data records including data fields in accordance with the equipment interface protocol;
one or more logic commands, executed by a logic program module located on the computer, for conditionally performing one or more of determining an output protocol for an output data, determining metadata to be added to the output data, determining additional data to be added to the output data, numerically and textually manipulating the equipment activity data, and identifying, filtering, organizing, and buffering the input equipment activity data;
one or more include commands, executed by an include program module located on the computer, for retrieving and adding one or both of the determined metadata, and the determined additional data to the output data;
one or more directives commands, executed by a directives program module located on the computer, for inserting content containing executable commands or text, wherein the inserted content specifies one or more of an input protocol, an out protocols, a source of input data, and a destination of the output data; and
one or more build commands, executed by a build program module located on the computer, for creating the output data in accordance to the output protocol, the output data including one or more of the data records, the data fields, the metadata, and the additional data.

8. A computer system in accordance with claim 7, wherein the equipment activity data is received in a plurality of equipment interface protocols, and wherein each of the equipment interface protocols is associated with one of a plurality of read program modules, located on the computer, for executing the one or more read commands for parsing the equipment activity data into data records including data fields in accordance with the equipment interface protocol.

9. A computer system in accordance with claim 7, wherein the additional data is one or more of an indicator, a value, a field, a data from one or more files, a label, an operating history for a given manufacturing device, a range for a rate of production, a number of objects produced by the manufacturing device, a number of produced objects that pass quality control inspection, a list of manufacturing devices involved in the production of an end product, a rate of production of the end product, and a limiting factor in the rate of production of the end product.

10. A computer system in accordance with claim 7, wherein the step of one or more logic commands executed by a logic program module, located on the computer, the logic commands causing the computer to determine an output protocol for an output data, to determine metadata to be added to the output data, and to determine additional data to be added to the output data includes:
program instructions to identify a relationship between the equipment activity data and one or both of the metadata or the additional data.

11. A computer system in accordance with claim 8, wherein the output data includes one or more of data records, reports, values, indicators, fields, files and labels.

12. A computer system in accordance with claim 7, wherein the metadata includes, for at least one of a manufacturing device, an item, a tool, or a process, one or more of a context for a characteristic, a use, a descriptive label for a data, a size of a data, and a format of a data embedded in an output data.

13. A computer program product to provide semantic enrichment of data, the computer program product comprising:
one or more computer-readable storage devices and program instructions stored on at least one of the one or more tangible storage devices, the program instructions comprising:
program instructions to receive real time equipment activity data from a manufacturing device, wherein the equipment activity data is in an equipment interface protocol; and
program instructions to read commands from a computer file in a special purpose language and perform actions on the equipment activity data in accordance with the commands;
wherein the commands include:
one or more read commands, executed by a read program module associated with the equipment interface protocol and located on the computer, for parsing the equipment activity data into data records including data fields in accordance with the equipment interface protocol;
one or more logic commands, executed by a logic program module located on the computer, for conditionally performing one or more of determining an output protocol for an output data, determining metadata to be added to the output data, determining additional data to be added to the output data, numerically and textually manipulating the equipment activity data, and identifying, filtering, organizing, and buffering the input equipment activity data;
one or more include commands, executed by an include program module located on the computer, for retrieving and adding one or both of the determined metadata, and the determined additional data to the output data;
one or more directives commands, executed by a directives program module located on the computer, for inserting content containing executable commands or text, wherein the inserted content specifies one or more of an input protocol, an out protocols, a source of input data, and a destination of the output data; and
one or more build commands, executed by a build program module located on the computer, for creating the output data in accordance to the output protocol, the output data including one or more of the data records, the data fields, the metadata, and the additional data.

14. The computer program product of claim 13, wherein the equipment activity data is received in a plurality of equipment interface protocols, and wherein each of the equipment interface protocols is associated with one of a plurality of read program modules, located on the computer, for executing the one or more read commands for parsing the equipment activity data into data records including data fields in accordance with the equipment interface protocol.

15. The computer program product of claim 13, wherein the additional data is one or more of an indicator, a value, a field, a data from one or more files, a label, an operating history for a given manufacturing device, a range for a rate of production, a number of objects produced by the manufacturing device, a number of produced objects that pass quality control inspection, a list of manufacturing devices involved in the production of an end product, a rate of production of the end product, and a limiting factor in the rate of production of the end product.

16. The computer program product of claim 13, wherein the step of one or more logic commands executed by a logic program module, located on the computer, the logic commands causing the computer to determine an output protocol for an output data, to determine metadata to be added to the output data, and to determine additional data to be added to the output data includes:
program instructions to identify a relationship between the equipment activity data and one or both of the metadata or the additional data.

17. The computer program product of claim 13, wherein the output data includes one or more of data records, reports, values, indicators, fields, files and labels.

18. The computer program product of claim 13, wherein the metadata includes, for at least one of a manufacturing device, an item, a tool, or a process, one or more of a context for a characteristic, a use, a descriptive label for a data, a size of a data, and a format of a data embedded in an output data.
